(19) United States
(12) Patent Application Publication
(10) Pub. No.: US 2010/0308286 A1
(43) Pub. Date: Dec. 9, 2010

(54) METHOD FOR THE SYNTHESIS OF TICON, TION AND TIO NANOPARTICLES BY LASER PYROLYSIS

(75) Inventors: Nathalie Herlin, Orsay (FR); Bruno Pignon, Joue Les Tours (FR); Hicham Maskrot, Antony (FR)

Correspondence Address: MCKENNA LONG & ALDRIDGE LLP, 1900 K STREET, NW, WASHINGTON, DC, 20006, US

(73) Assignees: COMMISSARIAT A' L ENERGIE ATOMIQUE, Paris (FR); UNIVERSITE FRANCOIS REBELAIS, Tours Cedex 1 (FR)

(21) Appl. No.: 12/678,089

(22) PCT Filed: Sep. 12, 2008
(86) PCT No.: PCT/FR2008/051637

§ 371 Date: Mar. 12, 2010

(30) Foreign Application Priority Data
Sep. 13, 2007 (FR) 07 06422

(51) Int. Cl. F21V 9/06; B01J 19/12; F21V 9/00

(52) U.S. Cl. 252/588; 204/157.41; 252/582

(57) ABSTRACT

The invention relates to the synthesis of a material including nanoparticles containing oxygen, titanium and nitrogen. According to the invention the method comprises the combustion by a temperature rise of at least 500° C. of a precursor containing at least titanium, oxygen and nitrogen. Advantageously, the combustion can be a laser pyrolysis and ammonia can be used both as a reagent supplying the nitrogen element for sensitising the pyrolysis reaction and as a fluid for carrying another reagent supplying the titanium element.

### TECHNICAL FIELD The present invention relates to the synthesis of powders from nanometric particles of nitrogenous and possibly carbonaceous titanium derivatives.

### PRIOR ART

Nanostructured materials have experienced a considerable development for a decade. This development is linked to a discovery of original properties that has thus opened up totally new fields of application in fields as varied as optics, catalysis, biotechnologies, electronics and others. For example, effects due to quantum confinement, such as the optical properties for silicon particles, are only observed for particles of a few nanometers. Thus, in the case of silicon, a reduction in the size of nanocrystals leads to opening the gap and typically brings about intense luminescence in the visible.

One possible application for titanium dioxide (TiO₂) in the form of a powder with nanometric particles is photocatalysis. It will be recalled that photocatalysis makes it possible to carry out chemical reactions in the presence of light. Its principle rests on the generation of electron-hole pairs in the semiconducting material by absorption of photons of which the energy is at least equal to the electronic gap of the material. These charge carriers will then react with chemical species on the surface of the material. It will then be understood that the positions of the edges of the valence and conduction band of the material then have great importance in performing the expected reaction.

Titanium dioxide TiO₂, in its anatase crystallographic form, is one of the materials most employed in photocatalysis, in particular on account of its chemical stability.

This application is of course mentioned here only as an example. It is indicated moreover that this material also seems to be a good candidate for applications in photovoltaic cells, notable with a view to replacing silicon.

More generally, titanium oxide is appreciated for its high optical absorption capacities.

Currently, a problem is however presented with this TiO₂ material on account of the large value of its gap (“optical gap”). More precisely, in the crystallographic phase of the “anatase” type of the TiO₂ material, the optical gap is as high as 3.2 eV. Since ultraviolet light (UV) only represents a small part of the solar spectrum, the possibility has been studied of synthesizing TiO₂ nanoparticles with a shifted gap, advantageously below 3 eV in order better to take advantage of the optical absorption capacities of TiO₂, typically in order to reach UV absorption notably within the range 290-350 nm or even up to 450 nm. One solution is to dope the TiO₂ material with transition metals or with anionic species such as nitrogen (N). However, preparation of these nanoparticles requires several chemical treatment steps that are cumbersome to put into operation as explained hereinafter.

Preparation of TiON.

The synthesis of TiON nanoparticles has, at the present time, only concerned nanoparticles with a low nitrogen content. Indeed, it has been demonstrated that a fall in photocatalytic activity exists when the nitrogen content in the particles is too high. In particular, an optimum concentration of 0.25 atomic percentage (TiO_{1.9925}N_{0.0075}) has been determined in the Asahi document:

“Visible-Light Photocatalysis in Nitrogen-Doped Titanium Oxides”, R. Asahi, T. Morikawa, T. Ohwaki, K. Aoki, Y. Taga. Science vol. 293, p 269 (2001).

Syntheses have been carried out by various methods.

In order to introduce nitrogen as a dopant, a first approach consists of adding triethylamine to a colloidal solution of nanoparticles.

A simpler approach in its implementation proposes, for obtaining a TiON powder, annealing conventional nanocrystals of TiO₂ in an ammonia atmosphere (possibly with argon) at 600° C. for 3 hours. This technique is described notably in the previously mentioned document by Asahi et al.

However, the annealing step in ammonia appears to be a restricting step since it employs a reagent that is not easy to handle and that leads moreover to grain growth.

All these methods for preparing TiON have thus in common the necessity for several chemical treatment steps.

Moreover, descriptions of the prior art do not give an indication of the yield or of production methods. In point of fact, these processes have been performed in batches and it is not certain that they can be exploited industrially continuously.

The present invention will improve the situation.

### PRESENTATION OF THE INVENTION

It proposes to this end to make use of the general combustion technique for obtaining nanocrystals containing at least titanium, oxygen and nitrogen.

Thus, the object of the present invention is first of all a method for synthesizing a material comprising nanocrystals containing titanium, oxygen and nitrogen.

The method involves combustion performed by laser pyrolysis, with a temperature rise of at least 500° C., of a precursor containing at least titanium, oxygen and nitrogen.

Such a method may lead to a material having a relatively low optical gap, for example below 3 eV.

Moreover, it has been observed that combustion within the context of the invention already makes it possible alone to dope nanocrystals of TiₓO_{y} with nitrogen, the ratio y/x being between 1 and 2, without it being necessary to make use of supplementary annealing in the presence of a compound containing nitrogen, such as ammonia. Consequently, chemical treatments within the context of the prior art, are avoided by implementing the present invention.

It is stated here that the term “doping” is taken to mean the fact that, in the crystalline structure of the particles obtained, sites normally dedicated to oxygen atoms are occupied by nitrogen atoms (doping by substitution) but also possibly the fact that nitrogen atoms can be incrusted as an inclusion in the TiₓO_{y} nanocrystals (interstitial doping), both types of doping being possible. However, for reasons of a search for homogeneity, it is preferred to obtain doping by substitution.

In addition, “combustion” will from now on be understood to mean physical synthesis, such as for example synthesis by flame or laser pyrolysis. Such techniques can be used continuously so that weighable quantities of powders with nanoparticles may be obtained, thus fulfilling the essential criterion for industrial development. Combustion has already been used on the industrial scale, for example to produce TiO₂ nanoparticles.

However, a combustion technique is also sought that is reproducible for producing particles that are uniform physically (shape, size, crystallinity) and chemically (composition). Laser pyrolysis for the provision of homogeneous nanocrystals has not yet been developed on an industrial scale, however it appears as a particularly suitable technique for meeting the criteria of uniformity of particles in the powders obtained. In particular, in order to control particle growth, and thus to obtain good uniformity in the shape and size of particles leaving the combustion flame, a technique is sought for procuring a toughening effect after combustion. Laser pyrolysis produces this toughening effect.

Thus, in an advantageous embodiment, combustion is, within the context of the invention, performed by laser pyrolysis.

Laser Pyrolysis

The principle of laser pyrolysis rests on the excitation of a compound, generally a precursor, which absorbs laser radiation and transmits its energy to all the reaction medium of which the temperature then increases very rapidly, producing a temperature increase greater than 500° C. for implementing the invention. A pyrolysis flame may then be observed. The reactant present in the precursor, brought to a high temperature, decomposes and after dissociation of the reactants, nanoparticles form and then undergo the aforementioned quench effect as they leave the flame. This sudden temperature fall has the effect of stopping the growth of particles and thus makes it possible to obtain particles with a nanometric size. The various adjustable parameters (throughput rates of reactants, choice of reactants, pressure, power and duration of laser bursts) advantageously make it possible to obtain nanocrystals with good physical and chemical uniformity as well as various products with a wide range of chemical compositions, size and crystallinity.

Pyrolysis corresponds to a chemical degradation reaction brought about by thermal energy that may be provided by an optical source. In addition “laser pyrolysis” is understood here to mean this technique consisting of encouraging pyrolysis by providing heat from an optical source that may be of any type (laser diode, gas laser, molecular laser, or others).

In point of fact, a coherent optical source may for example be a diode, more particularly a laser and more particularly a gas laser. Among gas lasers, it is preferable to employ molecular CO₂ lasers. This type of laser is currently employed in the pyrolysis field. Under this designation are grouped lasers having various compositions for the excitable gas, as much for an electrical or radiofrequency route as for a chemical one, notably containing CO₂ that may be associated with other gases, generating a coherent infrared source. The power of the source will generally be between 630 and 5000 W, typically between 630 and 1200 W (as will be seen in the examples hereinafter), and its wavelength between 9.3 and 11.6 μm, typically toward 10.6 μm. This type of source makes possible very localized heating and the formation of very high temperature gradients in the immediate proximity and in the exposure zone, which makes it possible to optimize the size of the nanoparticles. It is obviously desirable that one of the components of the precursor absorbs energy provided by the coherent source. Also, the wavelength could be modulated in this direction. The use of a sensitizer, as described hereinafter, permits greater latitude in the choice of precursors.

Pyrolysis is generally performed in a chamber isolated from the outer environment, particularly the atmosphere. Such a chamber is commonly designated by the term pyrolysis reactor. Such a reactor exists commercially and may be employed in the field of laser pyrolysis. The reactor is generally fitted with inlets controlling the flow of reactants (gaseous or liquid) forming the precursor, as well as for a carrier gas. For liquid reactants, it is advantageous to provide an aerosol generator.

The reactor additionally includes a zone in which the reactants are mixed, then forming the precursor on which pyrolysis will be carried out. This zone is generally situated upstream of the zone for exposure to the coherent laser source. Nanocrystals are recovered downstream of the exposure zone in a collecting zone.

Exposure may be made in a pulsed manner, it being possible for the exposure frequency to be of a few microseconds or, advantageously, continuously. It is possible to employ a focusing device such as an optical device, which is placed so that the optical source is focused on the precursor. The focusing device may notably be a cylindrical lens. Advantageously, it may consist of a ZnSe lens of which the resistance to infrared radiation is high. Focusing enables the power density to be increased in the exposure zone. Generally, it is recommended to have a power density between 350 and 1200 W/cm² for a non-focused beam and 2000 to 7000 W/cm² for a focused beam in the focal zone of the lens.

In this way, it is preferable for laser pyrolysis to employ laser radiation with a power of at least 600 W, radiation being focused in order to obtain a power density of at least 2000 W/cm².

Quenching Effect

According to a particular embodiment, it is possible to perform cold quenching following pyrolysis in order still further to produce a supplementary quenching effect. This quenching is generally performed by injecting cold gas after exposure of the mixture to the optical source so as to block particle growth. Thus, by aiming at the same particle size, it is possible to increase the production rate by employing this cold quenching. This quenching system may have an annular geometry, similar to quenching systems that may be used in plasma torches.

Choice of Reactants Forming the Precursor

Among the advantageous reactants providing the element titanium, mention may be made of titanium tetraisopropoxide (or TTIP hereinafter), in as much as it may also provide the element oxygen. Thus, the precursor may be composed of a mixture of at least:
a first reactant containing at least titanium, and
a second reactant containing nitrogen.

In one embodiment, it may moreover be advantageous for the reactant providing at least titanium to have a liquid phase, for example in the form of droplets. In this case TTIP may remain a good candidate for a first reactant.

However, in one variant, it may consist of titanium tetrachloride (TiCl₄) or a mixture of TTIP and titanium tetrachloride. In this case, provision of the element oxygen may be achieved by providing a stream of oxygen (O₂) for example added to titanium tetrachloride.

In the embodiment where combustion is performed by laser pyrolysis, it is advantageous for at least one of the reactants to absorb particularly the energy of optical radiation. Advantageously, the second reactant containing the element nitrogen may possess this property and have an optical absorption for laser radiation taking part in pyrolysis. Typically, if the laser radiation has a component in the infrared (for example a ray close to 10.6 μm), ammonia (NH₃) or monomethylamine (CH₃NH₂) or a mixture of these products, are each a good candidate for the second reactant.

Presence of Carbon in the Material Obtained

A “trace” of the combustion process within the context of the invention on the material obtained is that the latter has traces of carbon (at least 0.1% by weight of carbon).

In point of fact, for carrying out combustion, at least one reactant or a gas for carrying a reactant in the reactor or possibly a sensitizer (in laser pyrolysis), generally carries the element carbon, so that the material obtained contains carbon. More particularly, it may be thought that the element carbon is generally present in the form of carbon chains, close to nanocrystals of TiₓO_{y} doped with nitrogen, in the powder obtained. Thus, the carbon particles present in the powder could be independent of the doped TiₓO_{y} crystals, or sometimes be in the form of inclusions in the nanocrystals.

In order to reduce the proportion of carbon present in the material simple annealing of the material may be performed, advantageously in the ambient air. The annealing temperature may be of the order of 200 to 500° C., preferably of the order of 300 to 400° C., annealing itself being performed for one to eight hours, for example three to six hours, or for one to five hours, for example approximately six hours.

Thus, the material obtained by implementing the method may additionally contain carbon and, in addition, may encourage the presence of carbon by acting so that the precursor additionally contains carbon.

A first embodiment may simply consist of not attempting to avoid the presence of carbon in the powder obtained and then of choosing the first and/or second reactants (providing the element titanium and/or nitrogen) so that they also provide the element carbon.

A second embodiment consists of deliberately providing carbon from a third reactant taking part in the mixture forming the precursor and effectively containing carbon. Advantageously, this third reactant may be used for example as a sensitizer for pyrolysis. It may advantageously consist of, or at least contain, ethylene (C₂H₄).

Annealing Properties

More generally, an oxidation reaction may be carried out in order to limit the quantity of carbon present in the material following pyrolysis. The oxidation reaction may be carried out with the aid of an oxidant capable of reacting with carbon. This may notably consist of 0₂, N₂O, H₂O₂ or O₃. According to the oxidant employed it is of course useful to carry out oxidation under suitable conditions. Thus, for the most reactive oxidants, it will for example be useful to employ a high temperature. Typically, oxidation will be carried out in the presence of O₂ at a temperature between 200 and 500° C., and in particular close to 300° C. Oxidation may thus advantageously correspond to annealing carried out in ambient air or swept with synthetic air (O₂/N₂) at atmospheric pressure.

Oxidation is carried out until a desired carbon concentration is obtained in the material and it is possible to carry it out until virtually all the carbon has disappeared. It is recommended to follow the composition of the powder. To this end, it is notably possible to take samples and to employ spectroscopic methods to determine its composition. According to one particular method, it is possible to follow it simply by optical checks. In point of fact, as will be seen hereinafter, the powders obtained have different colorations observable to the naked eye. Thus, for example, carbon-rich powders have more of a green color—dark green or black (for a greater carbon content) while powders with a low carbon content are more likely to be yellow.

Extensions—Possible Variants

Choice of the First Reactant

The precursor mixture preferably contains the elements Ti, C, O, N and possibly H. It notably consists of organic, inorganic and/or organometallic compounds containing the aforementioned elements. A person skilled in the art will determine more precisely the composition of the mixture that he is likely to employ within the context of the invention. In point of fact, the operating principle for pyrolysis permits wide latitudes for maneuver by the user.

Thus, among the precursor mixtures, it will be possible to employ:
according to a first possibility, organometallic derivatives of titanium containing, in their organic part, the elements C, O, H and N, or
according to a second possibility, the titanium derivatives only contain part of these elements, the other elements being present in the form of organic compounds independent of titanium, or even
according to a third possibility, none of these elements, the latter being then present in the form of compounds independent of titanium.

According to the first possibility, it is thus in this way possible to use for example an organometallic compound derived from titanium of which the organic ligands are alcoholates containing mainly nitrogens.

According to the second possibility, it is possible to employ an organometallic titanium derivative of which the ligands may be for example alcoholates, such as alkyl alcoholates with 1 to 6 carbon atoms such as Ti(OiPr)₄) or Ti(OEt)₄, and to employ an organic compound containing nitrogen that may have a low molecular weight and correspond notably to NO₂, NH₃, H—₂NCH₃ or HNEt₂. In this case, the organometallic titanium derivative only contains part of the elements.

According to the third possibility, it is thus possible to employ titanium derivatives such as TiCl₄ and independent organic compounds.

Advantageously, the various compounds of the precursor mixture are selected so as not to react significantly with each other before being subjected to pyrolysis. In order to select them, it is thus possible to carry out tests by preparing various samples of the precursor mixture and to observe their respective behaviors under normal temperature and pressure conditions (or “NTPC” that is approximately 25° C. and 1 atm.) The user's choice will advantageously be focused on stable mixtures.

The constituents of the precursor mixture will be independently in liquid or gaseous form. When the precursor mixture or one of its constituents is/are in liquid or solid form under normal temperature and pressure conditions (NTPC), it is desirable to form an aerosol with the carrier gas, or to use it in gaseous form. The procedures for using liquid compounds in vapor form within the context of pyrolysis are notably described in the French patent application filed under number FR-07 00750. Typically, the flow as gas of the precursor may be continuous and controlled to this end on the liquid phase of the precursor before the latter is evaporated.

It is also possible to sublime any solid components.

Thus, the precursor mixture could be present in the form of an aerosol (droplets in liquid phase) or of a gas.

When the precursor mixture has the properties of an aerosol, it is recommended that the size of the droplets is micrometric. It is moreover preferable to dissolve some components of the precursor mixture in a solvent, notably solid or viscous liquid components. In particular, in the case of a standard aerosol generator, liquids of which the viscosity is greater than 5.10⁻³ Pa.s will be preferably dissolved in order to facilitate creation of an aerosol. Under these conditions, it is preferable for the solvent employed to correspond to one of the components of the precursor mixture or to one of the organic compounds that may be bound to titanium. Thus, the solvent may notably be isopropanol when the precursor is titanium tetrisopropoxide (TTIP). The components will be dissolved in the solvent in order to obtain a concentration such that a device generating the aerosol can operate. The quantity of solvent present generally brings about an increase in the quantity of carbon present in the powders obtained following pyrolysis.

Choice of the Second and/or Third Reactant

It will be recalled that a carrier gas then corresponds to a gas that enables the mixture to be conveyed to the optical source. Generally, the gas chosen for this purpose is stable. In any case, this type of gas is not completely destabilized, or in any case it is insufficiently able to react with the components of the precursor mixture. It may for example consist of a monatomic gas such as a rare gas such as argon or helium, or a stable polyatomic gas such as nitrogen (N₂). According to a particular embodiment, the carrier gas forms part of the components of the precursor mixture and in this way one of the reactants. It could for example consist of ammonia NH₃.

By means of the carrier gas, the mixture may be in the form of a gas flow (if the components of the precursor mixture are gaseous) or of an aerosol (if at least one of the components of the precursor mixture is liquid or solid under NTPC conditions), it being understood that in this case the use of a solvent can be useful. It is recommended that the main axis in which optical radiation is propagated (which typically corresponds to a laser beam) is orthogonal to the axis of the flow. The value of the stream, like the composition of the precursor mixture, may be modulated according to the user's wishes. Application of an iterative method, from a first result, enables a person skilled in the art to target more precisely the experimental conditions that are most suited to the composition of the material that it is desired to obtain. Usefully, it is nevertheless recommended to refer to the examples given hereinafter.

Apart from the carrier gas and the precursor, the mixture may include a sensitizer. In accordance with uses in the field of pyrolysis, it consists of a compound that makes it possible, according to requirements, to transfer energy more effectively from the source to precursor mixture, generally by collisional transfer. Use of a sensitizer is recommended notably when the precursor mixture does not absorb, or only slightly absorbs, the energy provided by the optical source. The use of sensitizers is known in the field of pyrolysis and a person skilled in art may thus choose the sensitizer that is best suited to the operating conditions. Usually, the sensitizer should not be decomposed under the experimental conditions of pyrolysis. The sensitizer generally corresponds to a low molecular weight organic compound. It may for example be chosen from SF₆ or preferably ethylene (C₂H₄).

Nevertheless, according to one particular embodiment, it is preferred here that one of the reactants of the precursor mixture is a sensitizer. It thus makes it possible to transfer energy provided by the optical source to all the precursor mixture. It is therefore preferable that the sensitizer contains at least one of the following elements: C, N, O and possibly H. Under these conditions, it is of course desirable that all or part of the sensitizer present is decomposed by the pyrolysis. Ammonia (NH₃) may then be employed as a sensitizer or for providing nitrogen. In addition, if it is also desired to provide carbon to the powder obtained, it may be provided as an ethylene (C₂H₄) sensitizer as a variant or even complementary to ammonia.

Properties of the Material Obtained

The object of the invention also relates to the material that can be obtained by implementation of the method and/or of its variants presented above.

The particles of the material obtained have a mean diameter generally between 5 and 40 nm and advantageously between 8 and 30 nm (mean equivalent diameter or “D_{BET}”). The mean specific surface area (or “S_{BET}”) lies between 30 and 100 m²/g.

In the test presented hereinafter, nanocrystals have been obtained advantageously in which the mean size is very small (8 nm in diameter with a standard deviation less than 3 nm) and offering the overall powder a greater photon exchange area than that obtained with techniques of the state of the art.

Concerning moreover the optical properties of the powder obtained, it is indicated that their optical gap is advantageously less than 3 eV and may be modulated according to the experimental conditions.

More generally, the material obtained by the method within the context of the invention is optically absorbent in the wavelength band of ultraviolet radiation including at least one band between 250 and 350 nm.

The particles have a crystalline structure in which the organization of the crystal lattice is variable. In particular, nanocrystals may have a crystallographic structure with a titanium monoxide phase TiO and/or a titanium dioxide TiO₂ phase and/or a Ti₄O₂ phase, each of these phases being possibly doped with nitrogen atoms.

The TiO₂ phase may possess a crystallographic morphology of the Brookite, anatase or rutile type for example.

It has advantageously been observed that it is possible to control the morphology of TiO nanoparticles notably by varying the quantity of energy received by the precursor mixture. In order to do this, two parameters may notably be modified: the power density in the exposure zone and the exposure time of the precursor mixture. It is thus possible to enrich the powder in TiO₂ nanoparticles in the rutile form by increasing the power received by the precursor mixture. For example, the size of the nanoparticles may be modulated by varying the reaction time, considered as the exposure time. This parameter may, for example, in the case where the optical source is a laser, be adjusted by varying the laser exposure frequency and/or by changing the rate of passage of the reactants. Typically by employing a non-focused laser, crystallized particles in the anatase phase are mainly obtained. The use of focusing may increase the proportion of the rutile phase until it is in the majority compared with that of the anatase phase. It is also possible to reach the Brookite phase by increasing the power density still further.

Thus, the nanocrystals obtained may have a crystallographic structure according to at least one of the following phases:
a TiO phase,
a Ti₄O₇ phase,
a first TiO₂ phase of the anatase type,
a second TiO₂ phase of the rutile type.

When a TiO₂ phase is present, the proportions at least of the first and second phases (possibly up to 0% of the second phase) may be controllable by the power density of the radiation.

It has been observed that the quantity of carbon in the material obtained tends to increase with the laser power and/or with the dwell time in the reactor (the dwell time varying inversely to the flow rate of the carrier gas). One possible interpretation is that some carrier gases or sensitizers containing the element C (for example ethylene if it is used), which are not normally reactive at low power, decompose at high laser power providing in this way more carbon. For example, for a laser power of between 1900 and 2420 W, it is possible to vary the elemental concentration of carbon within the powder between 5 and 20% for a carrier gas flow rate between 0.5 and 2 L.min⁻¹. Under these conditions, it has been possible to produce up to 22 g of powder an hour.

Generally, it is possible to obtain an elemental concentration of 0.5 to 10%, preferably 1 to 8%, of nitrogen by weight and 1 to 15% of carbon by weight in the material by using a laser power of 670 to 1070 W, for a carrier gas flow rate (and therefore of precursor) of between 0.5 and 2 L.min⁻¹. Typically, it is possible to produce in this way 2 to 9 g of powder an hour.

Thus, the method within the context of the invention is simple and reproducible. It makes it possible to produce Ti/C/O/N nanoparticles in a single step by laser pyrolysis, and also Ti/O/N nanoparticles simply by a supplementary annealing step in air at a low temperature (400° C. for example). Moreover, the method within the context of the invention makes it possible to obtain uniform small size particles with a good yield and an hourly production greater than that of the prior art.

### LIST OF FIGURES

Other features and advantages of the invention will become apparent on examining the following detailed description and the appended drawings in which:

FIG. 1 illustrates a pyrolysis installation in one embodiment example;

FIG. 2 illustrates a variant of the installation of FIG. 1;

FIG. 3 illustrates an image obtained by transmission electron microscopy (TEM) on a powder obtained directly leaving pyrolysis;

FIG. 4 illustrates an image obtained by transmission electron microscopy (TEM) on a powder obtained after annealing;

FIG. 5 illustrates the size distribution (in diameter) of particles of the powder of FIG. 3;

FIG. 6 illustrates the size distribution (in diameter) of particles of the powder of FIG. 4;

FIG. 7 shows diffractograms obtained for two materials according to two embodiments respectively;

FIG. 8 shows a diffractogram obtained for a material according to one embodiment;

FIG. 9 shows thee diffractograms for three materials respectively according to three embodiments; and

FIG. 10 shows optical absorption graphs as a function of energy according to the Kubelka Munk method, for two materials according to two examples of embodiments respectively, and for two materials known in the prior art.

### DETAILED DESCRIPTION

Examples of Combustion Installations

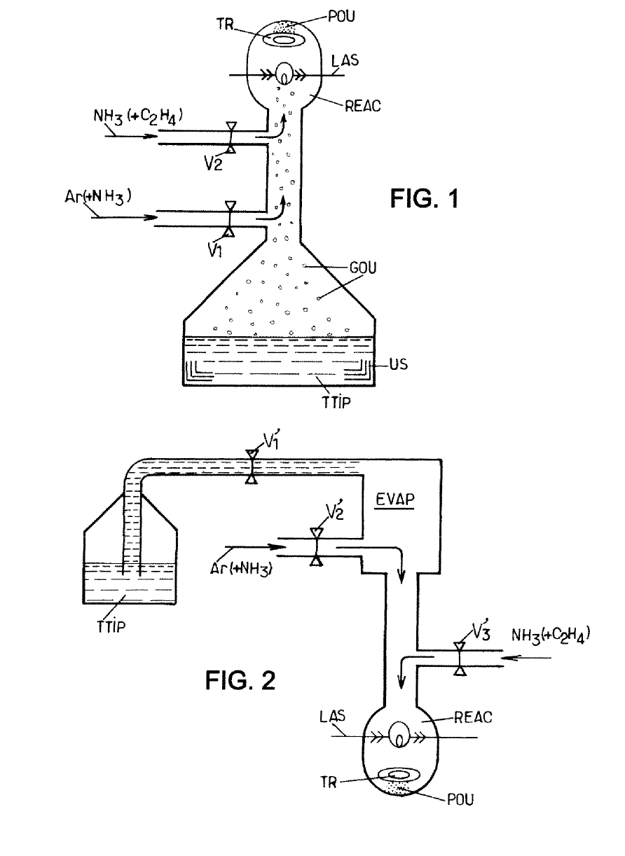

In the example represented in FIG. 1, combustion is carried out by laser pyrolysis, here in an aerosol installation as described for example in French patent application published under number FR-2 677 558. The precursor containing TTIP titanium is in liquid form and its surface is bombarded by ultrasound US to generate GOU droplets. A first inlet for a neutral gas such as argon (arrow AR) is advantageously provided in the installation so as to entrain droplets of the TTIP precursor. Advantageously, the flow rate of neutral gas is controlled by a flow meter V1. In this way, the neutral gas participating as a fluid conveying droplets of precursor GOU is controlled in its flow rate so that the dwell time of droplets in the reaction chamber REAC may be controlled at least by the flow meter V1. Advantageously, ammonia (NH₃) may be provided as a variant for argon, or complementary to argon, as the fluid carrying GOU droplets. A second inlet in the installation for injecting a sensitizer for the pyrolysis reaction is then provided, preferably downstream of the carrier gas inlet. Preferably, ammonia (NH₃) is used for providing the element nitrogen in the POU powder obtained. Ammonia may be injected on its own or complementary to ethylene (C₂H₄). Advantageously, the flow rate of sensitizer is controlled by a flow meter V2.

The reactor REAC is itself traversed by laser radiation LAS, advantageously with focusing means (not shown) on the zone of interaction with droplets of precursor. Pyrolysis then produces a flame. Particles leaving the flame undergo a quenching effect TR (for example by injecting a cold gas). A powder POU is finally collected then comprising nanocrystals containing at least titanium, oxygen, nitrogen and possibly carbon.

These nanocrystals advantageously have good optical properties in the UV range, in particular a very satisfactory absorption on account, on the one hand, of the presence of the element nitrogen among the reactants and, on the other hand, the good uniformity of the powder obtained by implementing the invention.

A particularly advantageous embodiment has made it possible to increase still further the optical absorption of the powder. It consists of the embodiment illustrated in FIG. 2 and in which the precursor is evaporated so that it reacts in the vapor phase with the laser radiation. This embodiment is described in the French patent application filed under number FR-0700750. With reference to FIG. 2, the TTIP precursor is initially in liquid form. In particular, a flow meter V′1 controls the flow rate of the TTIP precursor in its liquid phase. The precursor is then evaporated in an evaporator EVAP. A carrier gas (arrow Ar) as previously that may be a neutral gas such as argon with possibly a complement of ammonia (NH₃) (or as a variant ammonia alone) is provided, as before. The carrier fluid is controlled by the flow meter V′2. A sensitizer is also provided such as ammonia (NH₃) with, possibly, a complement (or as a variant) ethylene (C₂H₄) of which the flow is also controlled by a flow meter V′3. The precursor mixture carried by the carrier fluid and sensitizer are led to the reactor REAC. The pyrolysis reaction itself is carried out as described previously with reference to FIG. 1, the precursor being led here in a vapor phase continuously (on account of its flow being controlled in the liquid phase by the flow meter V′1) to the laser radiation LAS. This second embodiment generally produces smaller size particles and, in any case, a more uniform particle size than the first embodiment of FIG. 1.

In the embodiment of FIG. 1, as in the embodiment of FIG. 2, the optical radiation comes from a coherent source (preferably infrared), typically a CO₂ laser source that can deliver up to 5 kW in continuous mode. The rate of passage of the mixture in the laser exposure zone, and incidentally the dwell time of compounds, are typically imposed by the flow of carrier gas (neutral gas such as argon and possibly ammonia).

Examples of the Results Obtained

Various types of powders were obtained according to the conditions set out below, as will become apparent on reading the following examples, which have also the aim of illustrating the various features of the invention and which do not in any way aim at limiting the scope.

Four powders of the TiCON type are presented here as a function of the experimental conditions that have been employed in the method.

| | Carrier | Flow | Power | Ti | Nitrogen-containing | Production |
|---|---|---|---|---|---|---|
| Powder | gas | (cm³/min) | (W) | reactant | sensitizer (cm³/min) | (g/h) |
| TiCON16 | Helium | 2000 | 670 | TTIP | NH₃-400 | 9 |
| TiCON122 | Argon | Variable | 1060 | TTIP | NH₃- | 2 |
| | | | | | variable <20 | |
| TiCON123 | Argon | 500 | 1060 | TTIP | NH₃ - up to 20 | 2 |
| TiCON127 | Nitrogen | 750 | 1060 | TTIP | NH₃-100 | >2 |

The powders were prepared from the reactants TTIP and NH₃ that served respectively as a source for Ti, C and O and the source of N. The precursor TTIP was introduced by means of a 6 mm diameter injector, for example an aerosol of reference GOU in FIG. 1, at a rate of approximately 20-30 g.h⁻¹. The carrier gas helium, nitrogen or argon in the example described, had a flow rate of 2000 cm³.min⁻¹, in this way fixing the quantity of the precursor TTIP in the reactor. The sensitizer NH₃ was introduced at a flow rate of 400 cm³.min⁻¹ in the aerosol just before the reaction zone.

Irradiation was carried out with the aid of a CO₂ laser (with a power of 630-1200 W), focused with the aid of a 12 mm lens, of which the beam was perpendicular to the path of the gaseous solution.

TiON powders were then prepared by oxidizing TiCON powders such as previously obtained. Oxidation was carried out by annealing in air at atmospheric pressure directly in the collecting zone of the pyrolysis reactor.

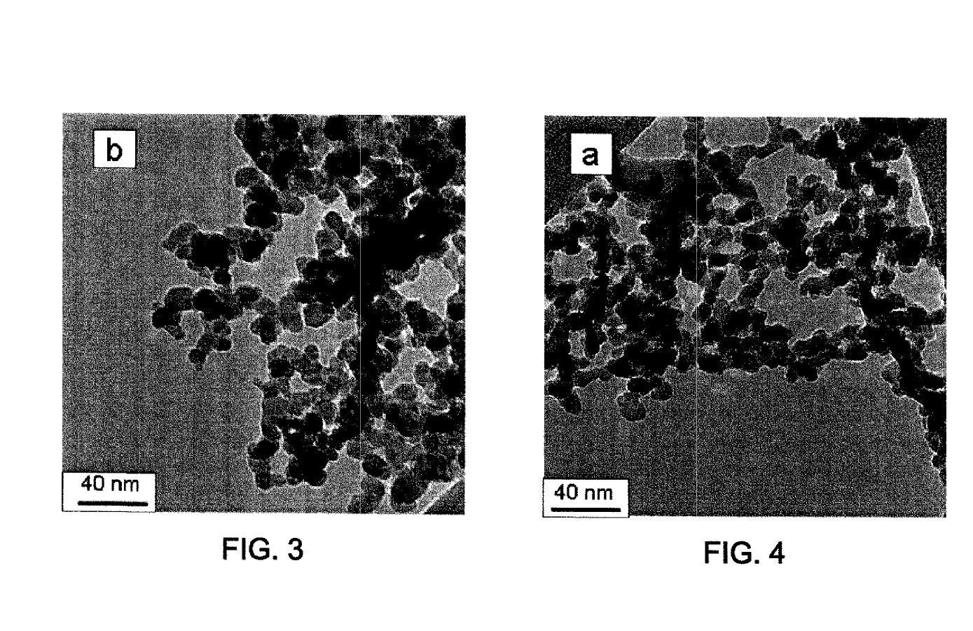

In particular, the TiCON16 powder (TEM image of FIG. 3), appearing to have a green color to the naked eye underwent annealing at 400° C. in ambient air for three hours. A TiON powder was obtained (TEM image of FIG. 4), and a color change of the powder towards yellow could be observed.

With reference to FIGS. 3 and 4, the nanoparticles of the green powder before quenching (FIG. 3) and the nanoparticles of the yellow powder after quenching (FIG. 4) were disposed in the form of chains. In both cases, the nanoparticles had an irregular surface and an elongated silhouette but a small size dispersion. Various values that could be obtained by analysis of these powders are given in table I below.

TABLE I

| | S_{BET} | D_{BET} | D_{TEM} | D_{XRD} |
|---|---|---|---|---|
| | (m² · g⁻¹) | (nm) | (nm) | (nm) |
| Green | 76 | 21 | 8-15 | 13.1 |
| powder | | | | |
| Yellow | 70 | 21 | 8-15 | 13.1 |
| powder | | | | |

From the images obtained by TEM (FIGS. 3 and 4), the particle size is typically between 8 and 15 nm (D_{IEM}). Such a value was less than the value 21 nm for the equivalent diameter (D_{BET}) calculated from measurements of the BET area, (for Brunauer, Emmet and Teller), for which it was assumed that the TiCON and TiON powders had the density of anatase. However, the size of between 8 and 15 nm was confirmed by X-ray diffraction measurements (D_{XRD}).

In this example, analysis by X-ray diffraction showed, diffraction peaks on nanocrystals attributed to the TiO₂ crystal in the anatase phase and the mean diameter of the nanoparticles (D_{XRD}), calculated with the method called Scherrer's method, was 13.1 nm.

Atomic compositions as well as the corresponding empirical formula from elemental mass analysis, have been given in table II below.

TABLE II

| | Ti (%) | O (%) | N (%) | C (%) | Empirical formula |
|---|---|---|---|---|---|
| Green | 36 | 58.3 | 2.2 | 3.4 | TiO_{1.6}N_{0.06}C_{0.09} |
| powder | | | | | |
| Yellow | 34 | 65.1 | 0.9 | 0.22 | TiO_{1.96}N_{0.03}C_{0.008} |
| powder | | | | | |

It appears that the green powder, before annealing, contains fifteen times more carbon than the yellow powder, after annealing. It will be noted however that the green powder on the other hand contains twice as much nitrogen as the yellow powder after annealing. This observation may be explained by an association between some nitrogen atoms and carbon atoms in the periphery of the crystals or as an inclusion therein. Thus, elimination of carbon after annealing also seems to bring about partial elimination of nitrogen. Nevertheless, it should be remembered that the quantity of carbon is substantially reduced in relation to that of nitrogen, after annealing (by a factor of approximately 7).

In addition, the green powder contains less oxygen than stoichiometric TiO₂. This observation may be explained by the fact that Ti³⁺ ions exist and oxygen gaps within the nanoparticles, or indeed on account of the presence of phases other than the TiO₂ phase.

The green powder obtained thus corresponds to an intermediate powder containing more carbon. However, carbon is present there only in very negligible quantities (a total of 3%) and the powder may already be used without annealing in the aforementioned optical absorption applications.

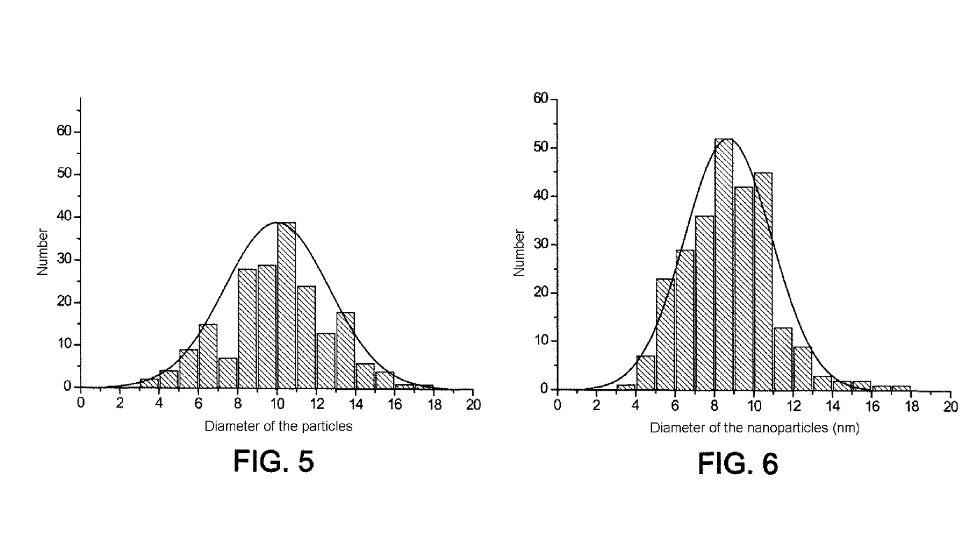

In addition, with reference to FIG. 5 illustrating the size distribution of particles obtained on the green powder before annealing, a very advantageous mean particle diameter of 8.7 nm appears with a standard deviation of 2.2, which shows both a small particle size and very good uniformity. On the other hand, in FIG. 6, illustrating the particle size distribution obtained on the yellow powder after annealing, a less advantageous mean appears of approximately 10 nm particle diameter with a standard deviation of 2.7. Consequently, it would seem that annealing slightly degrades grain uniformity and size.

XPS (for “X-ray Photoemission Spectrum”) analysis has shown, on this green powder before annealing, peaks associated with nitrogen (not shown in the figures), including:
an isolated peak, located at 396 eV that may be attributed to Ti—N bonds, proving the presence of nitrogen in substitution for an oxygen atom in the TiO lattice, and
two superimposed peaks observable between 401 and 398 eV that may be attributed to nitrogen linked to non-hydrogenated carbon, which would be present on the surface of the nanocrystals.

Consequently, it appears that the combustion method within the context of the invention leads directly to crystals of the TiₓO_{y} type, doped with nitrogen, the ratio y/x being between 1 and 2, and this doping is in no way due to annealing, as in the state of the art (the aforementioned Asahi et al. document). In addition, it may be recalled that annealing is optional when implementing the invention and aims at least at limiting the quantity of carbon.

The material obtained by the method within the context of the invention has in particular solar ray filtration properties at least within the UV B range and preferably within the UV B and UV A ranges.

Table III below gives filtration indices within the UV B range (290 nm-350 nm in long waves) and UV A (350-400 nm) for various powders obtained by the method within the context of the invention, to be correlated with the respective nitrogen and carbon proportions (percentage by weight), as well as the color of the powders obtained before annealing. It appears that high nitrogen doping (TICON127 powder) provides a filtration index of the same order of magnitude as a high carbon “pollution”, which blackens the powders (which may not be advantageous for applications where an esthetic effect is desired). In some applications for protection against UV rays such as for example for filtering UV B and/or UV A by motor vehicle glazing, it may be advantageous to control the optical properties and notably the color of the powder embedded in the composite forming the glazing. To this end, control of the respective proportions of carbon and nitrogen in the method within the context of the invention advantageously permits such applications.

As an indication, a pure TiO₂ powder is white.

TABLE III

| | | | Color | |
|---|---|---|---|---|
| | | | (before | Filtration |
| Powder | % C | % N | annealing) | index |
| IiCON16 | 1.4 | 1.1 | Green | 1000 |
| IiCON122 | 1.4 | <0.3 | Black | 120 |
| IiCON123 | 10.8 | 3.2 | Black | 4600 |
| IiCON127 | 3.8 | 8 | Greenish | 4000 |
| | | | khaki | |

The filtration index of table III may typically be measured as follows: 0.5 g of powder to be tested and 2.0 g of castor oil are ground with the aid of a plate grinder at a rate of twice 100 revolutions. The ground mixture obtained is then dispersed in collodion (15% nitrocellulose—42.5% ethyl acetate—42.5% butyl acetate) by agitation under ultrasound for approximately 15 minutes. The dispersion is then spread out on polymethyl methacrylate (PPMA) plates that are transparent to UV. The thickness of such a wet film is approximately 300 μm.

In addition, a film consisting of the same collodion and pure castor oil is prepared to serve as a reference for spectrophotometer measurements.

When the films are dry, an optical blank is prepared with the aid of the reference plate. Measurements are then carried out with the aid of a spectrophotometer (Scientec OL754 provided with a 75 W xenon lamp). The intensity of the light transmitted through the film between 290 nm and 400 nm is then measured and compared in the form of a ratio with the reference, which gives the value of the filtration index.

Filtration values are then obtained from the measurements in agreement with the procedure described in the document:

“A new substrate to measure sunscreen protection factor throughout ultraviolet spectrum”, B. I. Diffey and J. Robson, Journal of the Society of Cosmetic Chemists, vol. 40, p127-133 (1989),

a high filtration index indicating high light attenuation.

In a general manner, synthesis of a material including nanocrystals containing titanium, oxygen and nitrogen is carried out according to the invention by means of combustion by raising the temperature by at least 500° C., of a precursor containing at least titanium, oxygen and nitrogen. Advantageously, the combustion employed may be laser pyrolysis and ammonia may be used at the same time as:
a reactant providing nitrogen,
a sensitizer for the pyrolysis reaction,
and a fluid carrying another reactant providing the element titanium.

Other Examples of the Results Obtained

Experiments were carried out promoting a long dwell time, that is to say with relatively low TTIP carrier flow rates and in particular in the presence of NH₃ with a flow rate of 100 cm³/min, less than the 400 cm³/min of the previous results.

Four powders are presented here as a function of the experimental conditions that were employed in the method (focused laser):

| | Reactant: TTIP and carrier | | | | | |
|---|---|---|---|---|---|---|
| | Pre- | | | | | Pro- |
| Pow- | cursor | Flow rate, | | | Laser | duction |
| der | state | carrier gas | Gas | Flow rate | power | (g/h) |
| L | Gas | 50 g/h, | NH₃ | 100 cm³/min | 1900 W | 13 |
| | | Ar | | | | |
| M | Gas | 500 cm³/min, | NH₃ | 100 cm³/min | 1900 W | 8 |
| | | Ar | | | | |
| D | Aerosol | 750 cm³/min, | NH₃ | 100 cm³/min | 1000 W | 2 |
| | | Ar | | | | |
| O | Aerosol | 750 cm³/min, | NH₃ | 100 cm³/min | 1000 W | 2 |
| | | N₂ | | | | |

It may be envisaged that long dwell times induce more effective dissociation of TTIP and powders containing a high carbon content could be expected. The powders contained are effectively black in color.

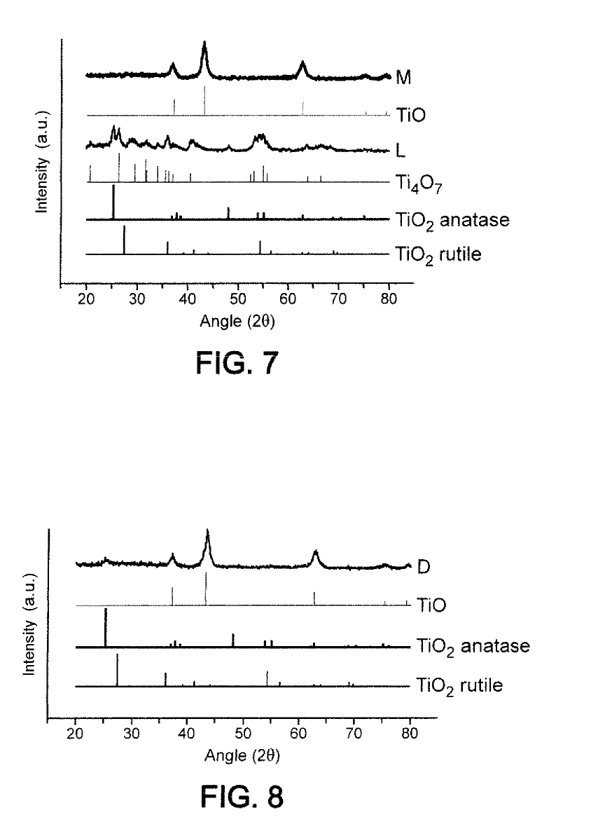

FIG. 7 shows diffractograms obtained by X-ray diffraction for the material M, to be compared with diffractograms for TiO, Ti₄O₇ and TiO₂ in the anatase and rutile form.

It follows that nanocrystals of the material M have a crystallographic structure principally with a titanium monoxide phase. The method described above surprisingly makes it possible in this way to obtain titanium monoxide in the form of nanoparticles, it being all the more interesting that titanium monoxide is not a natural form.

Moreover, it has been observed that the structure of the material M remains stable beyond one month. The method described above thus makes it possible to obtain nanoparticles with a stable TiO phase.

In addition, it follows from the X-ray diagram of the material L that the nanocrystals of this material L have a crystallographic structure according to at least one Ti₄O₇ phase and an anatase phase.

FIG. 8 shows the diffractogram obtained for the powder D. The X-ray diagram shows that the powder is rich in a TiO phase and also has a TiO₂ phase of the anatase type.

X-ray diffraction has thus made it possible to demonstrate the possibility of the presence, in nanoparticles obtained according to examples of embodiments, of phases other than the TiO₂ phase, for example TiO or Ti₄O₇ phases. It is possible that these phases are doped with nitrogen atoms.

In addition, it will be recalled that the L, M, D and O powders obtained are black in color. It is possible to carry out annealing in order to reduce the carbon content, it being possible for the dark color of the powders to be prejudicial according to the applications, for example for applications requiring optical transmission or applications for which an esthetic effect is desired.

For example, for an application for filtering the sun's UV B and UV A rays for glazing of motor vehicles, windows of dwellings or for spectacles, it may be advantageous to control the optical properties and notably the color of the powder embedded in the composite forming the glazing, window or glass of the spectacles, respectively.

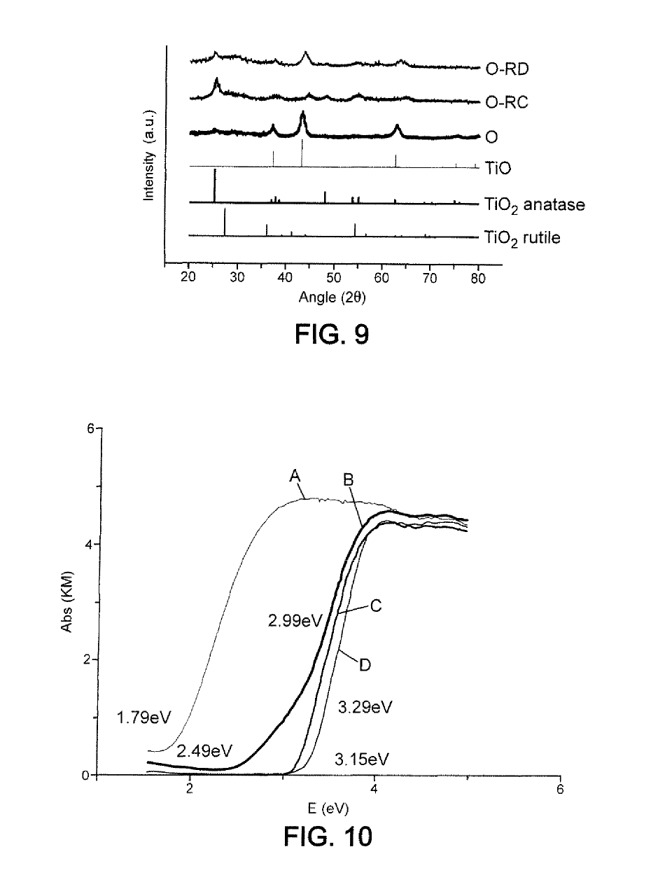

FIG. 9 shows the diffractogram obtained for the powder O, the diffractogram obtained for this same powder O after annealing referred to as “conventional” at 400° C. for 3 hours in air (diffractogram O-RC), and the diffractogram for this same powder O after milder annealing at 300° C. for 6 hours in air (diffractogram O-RD).

The X-ray diagram of the O powder shows the presence of a TiO phase and the presence of an anatase phase.

The diffractogram O-RC shows that after annealing the O powder at 400° C. for 3 hours in air, the TiO phase has completely or almost completely disappeared. The nanocrystals then seem to be mainly composed of an anatase phase of TiO₂.

The diffractogram O-RD 300° C. shows that after milder annealing at 300° C. for 6 hours, the TiO phase continued to exist with the anatase phase.

It is possible that annealing, by limiting the carbon content, leads to a modification of the structure of the powder and promotes oxidation of titanium with an enrichment of the TiO₂ phase in the anatase or rutile form for example. In particular, annealing of the powder L comprising a Ti₄O₇ phase, leads to oxidation to a TiO₂ phase.

These structural modifications change the optical absorption properties of the powder, in particular the optical gap.

The annealing conditions may thus determine the color of the powder and the optical gap.

The choice of relatively mild annealing conditions may thus make it possible to reconcile a reduction in the carbon content with maintenance of a less oxidized phase than TiO₂, for example the TiO phase. Thus, the powder O, after relatively mild annealing at 300° C. for 6 hours, has an orange-brown color that remains compatible with some applications, while preserving a relatively small gap as will be seen when referring to FIG. 10 described below.

FIG. 10 shows in point of fact optical absorption graphs with an essentially rutile powder (curve C), an essentially anatase powder (curve D), a powder of material O after conventional annealing at 400° C. for 3 hours in air (curve B) and a powder of material O after relatively mild annealing at 300° C. for 6 hours in air (curve A).

This figure shows that the powders derived from annealing material O (curves A and B) have smaller optical gaps compared with essentially anatase or rutile powders.

These gap extensions towards low energies may be of particular value for applications requiring extended absorption in the corresponding zone of the spectrum, for example for sun protection applications.

In particular, the powder derived from mild annealing has a relatively small shifted optical gap of approximately 1.8 eV. The small value of the optical gap is associated with the presence of the TiO phase.

It has been observed that this TiO phase is relatively stable over periods greater than one month, in the powder derived from mild annealing (corresponding to curve A).

The filtration index measured under the same conditions as set out above is 1420.

The choice of mild annealing thus seems advantageous since the proportion of UV rays filtered by the powder obtained is relatively high, on account of the small optical gap, the color of the powder obtained remaining satisfactory.

However, it will be understood that it remains possible to adjust the annealing conditions according to the desired optical gap. In particular, the annealing conditions may be optimized according to the desired color and the desired optical properties, or other constraints according to the desired applications.

1. A method for synthesizing a material comprising nanocrystals containing titanium, oxygen and nitrogen, wherein the method includes combustion carried out by laser pyrolysis, with a temperature rise of at least 500° C., of a precursor containing at least titanium, oxygen and nitrogen.

2. The method as claimed in claim 1, wherein combustion is followed by a quenching effect.

3. The method as claimed in claim, wherein laser pyrolysis employs laser radiation with a power of at least 600 W, radiation being focused in order to produce a power density of at least 2000 W/cm².

4. The method as claimed in claim 3, wherein the nanocrystals have a crystallographic structure according to at least one of the following phases:
a titanium monoxide TiO phase,
a titanium dioxide TiO₂ phase.

5. The method as claimed in claim 4, wherein the titanium dioxide phase is composed of titanium dioxide in the anatase form and titanium dioxide in the rutile form,
and wherein the relative proportions of titanium dioxide in the anatase form and of titanium dioxide in the rutile form are functions of power density of the radiation.

6. The method as claimed in claim 1, wherein the precursor is a mixture of at least:
a first reactant containing at least the element titanium, and
a second reactant containing the element nitrogen.

7. The method as claimed in claim 6, wherein at least the first reactant comprises a liquid phase in the form of droplets.

8. The method as claimed in claim 7, wherein the first reactant comprises titanium tetraiosopropoxide.

9. The method as claimed in claim 7, wherein the first reactant comprises titanium tetrachloride.

10. The method as claimed in claim 7, wherein the first reactant additionally contains the element oxygen.

11. The method as claimed in claim 9, wherein a stream of oxygen is further added to titanium tetrachloride.

12. The method as claimed in claim 6, wherein the second reactant contains an optical absorbent for a laser radiation taking part in pyrolysis.

13. The method as claimed in claim 12, wherein the second reactant comprises ammonia, and wherein the laser radiation contains at least one infrared component.

14. The method as claimed in claim 12, wherein the second reactant comprises monomethylamine and wherein the laser radiation contains at least one infrared component.

15. The method as claimed in claim 6, wherein the second reactant is used as a fluid for carrying the first reactant to a combustion reactor.

16. The method as claimed in claim 1, wherein the material additionally contains carbon.

17. The method as claimed in claim 16, wherein the precursor additionally contains carbon.

18. The method as claimed in claim 6, wherein at least the first reactant contains carbon.

19. The method as claimed in claim 6, wherein the mixture contains a third reactant containing carbon.

20. The method as claimed in claim 19, wherein the third reactant is used as a sensitizer in combustion.

21. The method as claimed in claim 19, wherein the third reactant comprises ethylene.

22. The method as claimed in claim 16, wherein it comprises, after combustion, oxidation of the material in order to reduce the proportion of carbon in the material.

23. The method as claimed in claim 22, wherein it includes annealing in air at a temperature of the order of 200 to 500° C., said annealing being carried out for one to eight hours.

24. The method as claimed in claim 23, wherein it includes annealing in air at a temperature of the order of 300° C., said annealing being carried out for six hours.

25. The method as claimed in claim 1, wherein the material is obtained in the form of a powder at a rate of between 2 and 22 grams an hour.

26. A material comprising nanocrystals containing titanium, oxygen and nitrogen, comprising:
carbon chains, and
nanocrystals of titanium dioxide doped with nitrogen, in which a nitrogen atom occupies a site dedicated to an oxygen atom.

27. The material as claimed in claim 26, containing at least 0.1% by weight of carbon.

28. (canceled)

29. The material as claimed in claim 26, wherein the nanocrystals have a mean diameter of between 5 and 40 nm and preferably between 8 and 30 nm.

30. The material as claimed in claim 26, containing between 0.5 and 10% nitrogen.

31. The material as claimed in claim 26, having an optical gap less than 3 eV.

32. The material as claimed in claim 26, optically absorbent in a wavelength band of ultraviolet radiation including at least one band between 250 nm and 400 nm and preferably from 250 to 350 nm.

33. The material as claimed in claim 26, having properties of filtering the sun's rays at least within the UV B range, and preferably within the UV B and UV A ranges.

34. The material as claimed in claim 26, obtained by implementing the method as claimed in claim 22, wherein it changes from a green color to a yellow color after oxidation.

35. The material obtained by implementing the method as claimed in claim 1, wherein it comprises nanocrystals with a stable titanium monoxide TiO phase.

36. The material as claimed in claim 35, obtained by implementing the method as claimed in claim 24, comprising titanium monoxide so as to have an optical gap close to 1.8 eV.

37. The material as claimed in claim 36, having an orange-brown color.
